(19) United States
(12) Patent Application Publication
(10) Pub. No.: US 2015/0199206 A1
(43) Pub. Date: Jul. 16, 2015

(54) DATA DISTRIBUTION DEVICE AND DATA DISTRIBUTION METHOD THEREOF FOR USE IN STORAGE SYSTEM

(71) Applicant: BIGTERA LIMITED, Kowloon (HK)

(72) Inventors: Cheng-Yue CHANG, Taipei City (TW); Tsung-Lin YU, Taipei City (TW)

(73) Assignee: BIGTERA LIMITED, Kowloon (HK)

(21) Appl. No.: 14/153,518

(22) Filed: Jan. 13, 2014

(51) Int. Cl. G06F 9/455

(52) U.S. Cl. CPC G06F 9/45533

(57) ABSTRACT

A data distribution device and a data distribution method for use in a storage system including a plurality of storage servers are provided. The data distribution device includes a location recorder and a processor electrically connected with the location recorder. The location recorder is configured to record locations of a plurality of hypervisors and the storage servers. The processor is configured to capture information of at least one virtual machine related to the hypervisors; create a data distribution policy for the virtual machine according to the information and the locations of the hypervisors and the storage servers; and notify the storage system of the data distribution policy. The data distribution method is applied to the data distribution device to implement the aforesaid operations.

### CROSS-REFERENCES TO RELATED APPLICATIONS

Not applicable.

### BACKGROUND OF THE INVENTION

1. Field of the Invention

The present invention relates to a data distribution device and a data distribution method thereof. More particularly, the present invention relates to a data distribution device and a data distribution method thereof for use in a storage system.

2. Descriptions of the Related Art

A network attached storage (NAS) system is a storage system which has been extensively used in companies. Since the NAS can support many standard network file systems, it can be readily used to store and share data for its clients. Because a client's need for storage may alter over time, a conventional storage structure, known as a scale-out NAS structure, has been provided over recent years.

With the scale-out NAS structure, data is distributed evenly to all the storage servers. As applied to a virtual environment, the even distribution may result in data corresponding to a virtual machine of a hypervisor to be distributed to some storage servers that are located far from the hypervisor. As a result, the efficiency of the virtual machine is decreased since the transmission time of the data is extended.

In view of this, it is important to improve the efficiency of virtual machines in conventional scale-out NAS structures.

### SUMMARY OF THE INVENTION

An objective of the present invention is to improve the efficiency of virtual machines in conventional scale-out NAS structures.

To achieve the aforesaid objective, the present invention provides a data distribution device for use in a storage system comprising a plurality of storage servers. The data distribution device comprises a location recorder and a processor electrically connected with the location recorder. The location recorder is configured to record locations of a plurality of hypervisors and the storage servers. The processor is configured to capture information of at least one virtual machine related to the hypervisors; create a data distribution policy for the at least one virtual machine according to the information and the locations of the hypervisors and the storage servers; and notify the storage system of the data distribution policy.

To achieve the aforesaid objective, the present invention further provides a data distribution method of a data distribution device for use in a storage system comprising a plurality of storage servers. The data distribution device comprises a location recorder and a processor electrically connected with the location recorder. The data distribution method comprises the following steps:

(a1) recording locations of a plurality of hypervisors and the storage servers by the location recorder;

(b1) capturing information of at least one virtual machine related to the hypervisors by the processor;

(c1) creating a data distribution policy for the at least one virtual machine according to the information and the locations of the hypervisors and the storage servers by the processor; and

(d1) notifying the storage system of the data distribution policy by the processor.

In summary, the present invention provides a data distribution device and a data distribution method thereof. Unlike conventional scale-out NAS structures, the data distribution device and data distribution method can dynamically create a data distribution policy for at least one virtual machine and notifies the storage system of the data distribution policy according to the aforesaid arrangements of the location recorder and the processor. In such a way, data corresponding to at least one virtual machine of a hypervisor will not be distributed to some storage serves that are located far from the hypervisor. Consequently, the present invention improves the efficiency of virtual machines in conventional scale-out NAS structures.

The detailed technology and preferred embodiments implemented for the present invention are described in the following paragraphs accompanying the appended drawings for persons skilled in the art to well appreciate the features of the claimed invention.

### BRIEF DESCRIPTION OF THE DRAWINGS

FIG. 1 is a schematic view of a storage structure in a virtual environment according to a first embodiment of the present invention;

FIG. 2 is a schematic view of a network connection arrangement for hypervisors and storage servers according to a first embodiment of the present invention; and

FIG. 3 is a diagram of a data distribution method for use in a storage system according to a second embodiment of the present invention.

### DESCRIPTION OF THE PREFERRED EMBODIMENT

The present invention may be explained with reference to the following embodiments. However, these embodiments are not intended to limit the present invention to any specific environments, applications or implementations described in these embodiments. Therefore, the description of these embodiments is only for the purpose of illustration rather than limitation. In the following embodiments and attached drawings, elements not directly related to the present invention are omitted from depiction. In addition, the dimensional relationships among individual elements in the attached drawings are illustrated only for ease of understanding, but not to limit the actual scale.

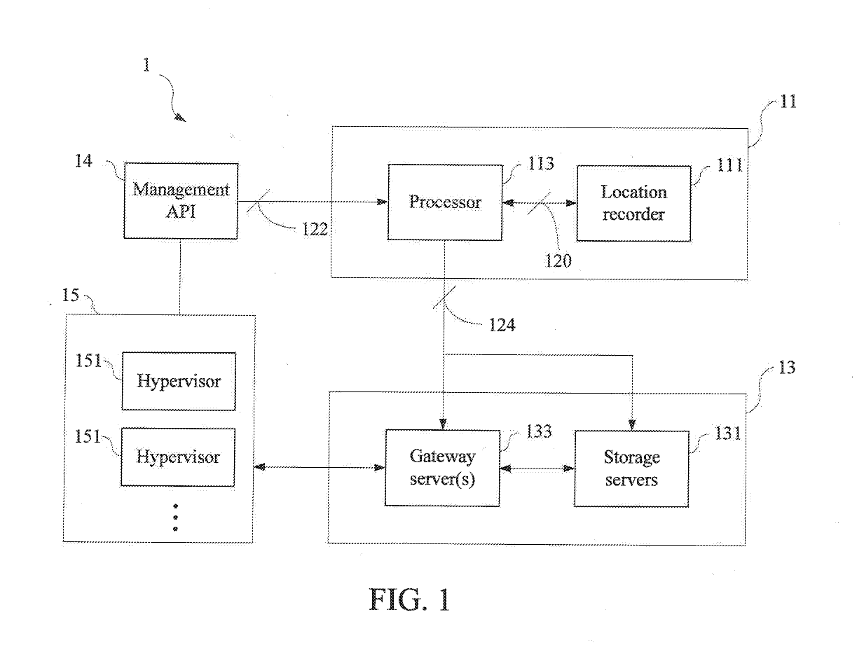

A first embodiment of the present invention is a data distribution device. A schematic view of a storage structure 1 in a virtual environment is shown in FIG. 1. The storage structure 1 comprises a data distribution device 11, a storage system 13 and a virtualization infrastructure system 15. The data distribution device 11 comprises a location recorder 111 and a processor 113 electrically connected with the location recorder 111. The storage system 13 comprises a plurality of storage servers 131 and at least one gateway server 133 (i.e., one or multiple gate way servers). The storage system 13 may be, but is not required to be, a scale-out NAS system.

The virtualization infrastructure system 15 communicates with the storage servers 131 via the at least one gateway server 133. The virtualization infrastructure system 15 may communicate with the at least one gateway server 133 according to network file system (NFS) protocols or internet small computer system interface (iSCSI) protocols. When the at least one gateway server 133 receives an I/O request from the virtualization infrastructure system 15, it will access data between the storage servers 131 and virtualization infrastructure system 15. One gateway server 133 and one of the storage servers 131 may be integrated into a single server; or they may be separated from each other.

The virtualization infrastructure system 15 may comprise a plurality of hypervisors 151. In addition, similar to conventional scale-out NAS structures, the virtualization infrastructure system 15 may provide its interior information via a management application programming interface (API) 14 so that any external system can locate the information. Therefore, the processor 113 of the data distribution device 11 may comprise a victual machine (VM) event observer to monitor the virtualization infrastructure system 15 via the management API 14 and further capture the information 122 of at least one virtual machine (i.e., one or multiple virtual machines) related to the hypervisors 151.

Specifically, the information 122 of the at least one virtual machine may comprise creation information, deletion information, startup information, poweroff information and migration information. According to the information 122 of the at least one virtual machine, the processor 113 of the data distribution device 11 can dynamically obtain the status of the at least one virtual machine. For example, when the virtualization infrastructure system 15 creates a virtual machine, the processor 113 of the data distribution device 11 can immediately know which hypervisor 151 creates the virtual machine according to the information 122. As another example, when the virtualization infrastructure system 15 moves a virtual machine from one hypervisor 151 to another, the processor 113 of the data distribution device 11 can immediately determine the destination of the hypervisor 151 to which the virtual machine is moved according to the information 122.

The location recorder 111 of the data distribution device 11 may comprise a location map to record locations 120 of the hypervisors 151 and the storage servers 131. The locations 120 of the hypervisors 151 and the storage servers 131 may be recorded in internet protocol form, but this is not a limitation. In such a way, the location 120 of one hypervisor 151/storage server 131 recorded by the location recorder 111 of the data distribution device 11 indicates the internet protocol address of the hypervisor 151/storage server 131. According to the location 120 recorded by the location recorder 111, the data distribution device 11 can obtain the location differences between each hypervisor 151 and each storage server 131. The location 120 may be recorded automatically by the location recorder 111 or recorded manually by an information technology administrator.

The processor 113 of the data distribution device 11 further creates a data distribution policy 124 for at least one virtual machine according to the information 122 of the at least one virtual machine and the locations 120 of the hypervisors 151 and the storage servers 131. The data distribution policy 124 may conform to a rule where data corresponding to a virtual machine of a hypervisor 151 is not distributed to some storage servers 131 which are located far from the hypervisor 151.

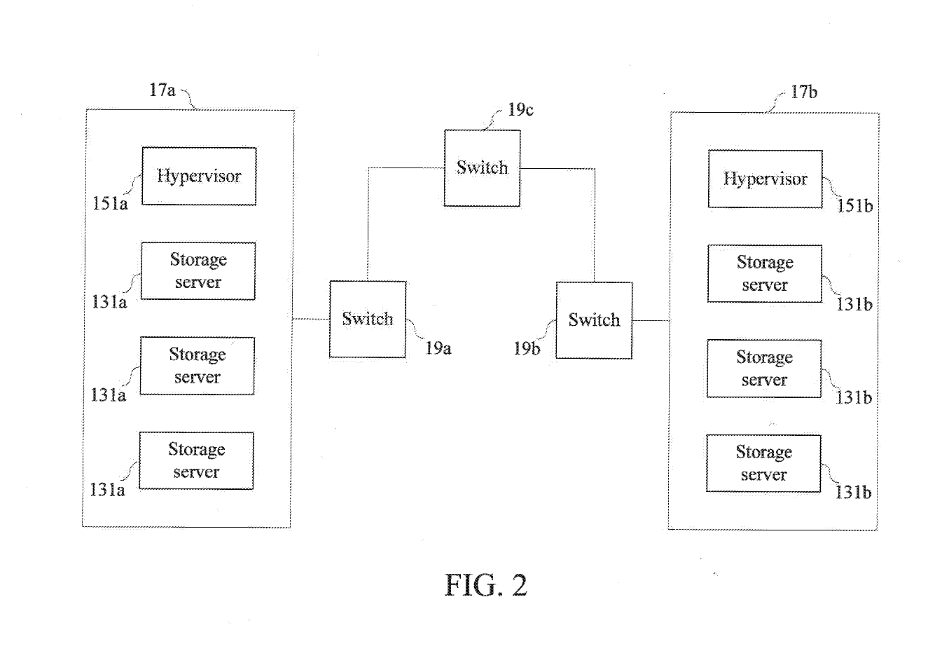

FIG. 2 is a schematic view of a network connection arrangement for the hypervisors 151 and the storage servers 131. It is an example to further describe the data distribution policy 124. As shown in FIG. 2, one hypervisor 151a and three storage servers 131a are disposed in the same rack 17a, and they communicate with each other via a local switch 19a. In addition, one hypervisor 151b and three storage servers 131b are disposed in the same rack 17b, and they communicate with each other via another local switch 19b. The switch 19a is connected with the switch 19b via a bridge switch 19c.

Under the structure of FIG. 2, if a virtual machine created on the hypervisor 151a wants to access data with one of the storage servers 131b, the data has to be transmitted through the local switch 19a, the bridge switch 19c and the local switch 19b. However, if the hypervisor 151a wants to access the data with one of the storage servers 131a, the data can be transmitted directly to the target storage server 131 in the local network provided by the local switch 19a. Obviously, the transmission time of the data of the former is slower than that of the latter.

Therefore, if the virtualization infrastructure system 15 creates a virtual machine on the hypervisor 151a, the processor 113 of the data distribution device 11 will create a data distribution policy 124 for the virtual machine of the hypervisor 151a. According to the data distribution policy 124, data corresponding to the virtual machine of the hypervisor 151a is distributed to the storage servers 131a because the storage servers 131a and the hypervisor 151a are disposed in the same rack 17a. In other words, the data distribution policy 124 can avoid the distribution of the data to any of the storage servers 131b because the storage servers 131b disposed in the rack 17b are far away from the hypervisor 151a disposed in the rack 17a.

Next, if the virtualization infrastructure system 15 moves the virtual machine from the hypervisor 151a to the hypervisor 151b, the processor 113 of the data distribution device 11 will create a data distribution policy 124 for the virtual machine of the hypervisor 151b. According to the data distribution policy 124, data corresponding to the virtual machine of the hypervisor 151b is distributed to the storage servers 131b because the storage servers 131b and the hypervisor 151b are disposed in the same rack 17b. In other words, the data distribution policy 124 can avoid the distribution of the data to any of the storage servers 131a because the storage servers 131a disposed in the rack 17a are far from the hypervisor 151b disposed in the rack 17b. When the virtual machine is moved as described above, the data distribution policy 124 may also instruct the storage system to move the data from the previous storage servers 131a to the target storage servers 131b.

Upon creating the data distribution policy 124, the processor 113 of the data distribution device 11 notifies the storage system 13 of the data distribution policy so that the data corresponding to the virtual machine of a hypervisor 151 can be adaptively distributed according to the data distribution policy 124 by the storage system 13. Specifically, the processor 113 of the data distribution device 11 may notify the storage servers 131 of the data distribution policy 124 so that the storage servers 124 stores data of the at least one virtual machine according to the data distribution policy 124. Furthermore, the processor 113 of the data distribution device 11 may notify the at least one gateway server 133 of the data distribution policy 124 so that the at least one gateway server 133 controls access of the data between the at least one virtual machine and the storage servers 131 according to the data distribution policy 124.

A second embodiment of the present invention is a data distribution method of a data distribution device for use in a storage system comprising a plurality of storage servers. The data distribution method described in this embodiment may be applied to the data distribution device 11 described in the first embodiment. Therefore, the data distribution device described in this embodiment may be considered as the data distribution device 11 described in the first embodiment. The data distribution device may comprise a location recorder and a processor electrically connected with the location recorder.

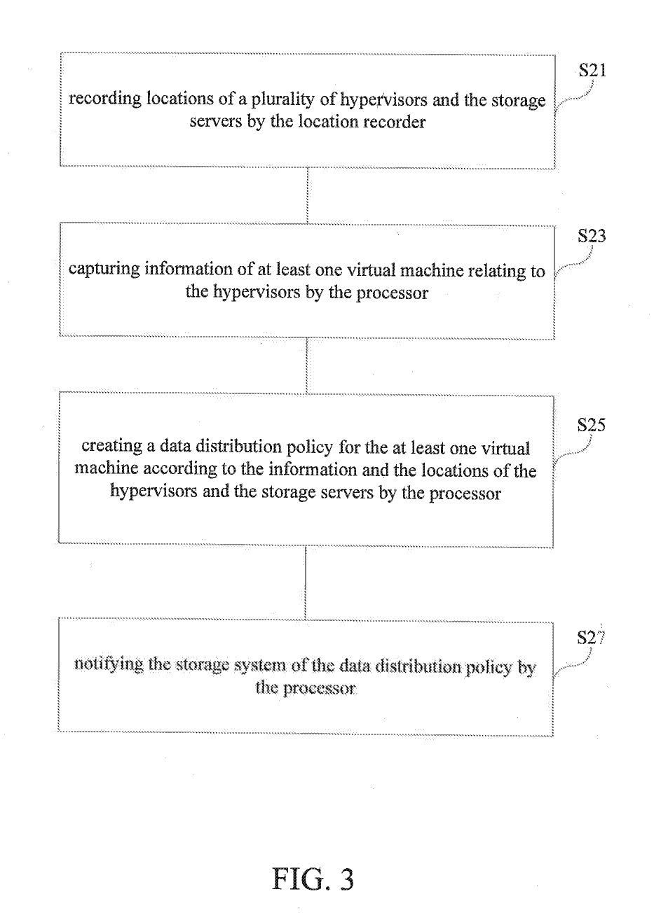

A diagram of a data distribution method for use in a storage system is shown in FIG. 3. As shown in FIG. 3, step S21 is executed to record locations of a plurality of hypervisors and the storage servers by the location recorder. Step S23 is executed to capture information of at least one virtual machine related to the hypervisors by the processor. Step S25 is executed to create a data distribution policy for the at least one virtual machine according to the information and the locations of the hypervisors and the storage servers by the processor. Step S27 is executed to notify the storage system of the data distribution policy by the processor.

In one example of this embodiment, step S27 may further comprise a step of notifying the storage servers of the data distribution policy by the processor so that the storage servers stores data of the at least one virtual machine according to the data distribution policy. Furthermore, step S27 may further comprise another step of notifying the at least one gateway server of the data distribution policy by the processor so that the at least one gateway server controls access of the data between the at least one virtual machine and the storage servers according to the data distribution policy.

In one example of this embodiment, the processor captures the information from a virtualization infrastructure system via a management application programming interface.

In one example of this embodiment, the locations of the hypervisors and the storage servers are recorded in internet protocol form.

In one example of this embodiment, the information of the at least one virtual machine comprises creation information, deletion information, startup information, poweroff information and migration information. In one example of this embodiment, the storage system is a scale-out network attached storage system.

In addition to the aforesaid steps, the data distribution method of this embodiment further comprises other steps corresponding to all the operations of the data distribution device 11 set forth in the first embodiment and accomplishes all the corresponding functions. Since the steps which are not described in this embodiment can be readily appreciated by persons skilled in the art based on the explanations of the first embodiment, they will not be further described herein.

According to the above descriptions, the present invention provides a data distribution device and a data distribution method thereof. Unlike conventional scale-out NAS structures, according to the aforesaid arrangements of the location recorder and the processor, the data distribution device and the data distribution method can dynamically create a data distribution policy for at least one virtual machine and notifies the storage system of the data distribution policy. In such a way, data corresponding to the at least one virtual machine of a hypervisor will not be distributed to some storage servers that are located far from the hypervisor. Consequently, the present invention improves the efficiency of virtual machines in conventional scale-out NAS structures.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data distribution device for use in a storage system, the storage system comprising a plurality of storage servers, the data distribution device comprising:
a location recorder, configured to record locations of a plurality of hypervisors and the storage servers; and
a processor, electrically connected with the location recorder and configured to:
capture information of at least one virtual machine related to the hypervisors;
create a data distribution policy for the at least one virtual machine according to the information and the locations of the hypervisors and the storage servers; and
notify the storage system of the data distribution policy.

2. The data distribution device as claimed in claim 1, wherein the processor notifies the storage servers of the data distribution policy so that the storage servers stores data of the at least one virtual machine according to the data distribution policy.

3. The data distribution device as claimed in claim 2, wherein the storage system further comprises at least one gateway server, and the processor further notifies the at least one gateway server of the data distribution policy so that the at least one gateway server controls access of the data between the at least one virtual machine and the storage servers according to the data distribution policy.

4. The data distribution device as claimed in claim 1, wherein the processor captures the information from a virtualization infrastructure system via a management application programming interface (API).

5. The data distribution device as claimed in claim 1, wherein the locations of the hypervisors and the storage servers are recorded in internet protocol form.

6. The data distribution device as claimed in claim 1, wherein the information of the at least one virtual machine comprises creation information, deletion information, startup information, poweroff information and migration information.

7. The data distribution device as claimed in claim 1, wherein the storage system is a scale-out network attached storage system.

8. A data distribution method of a data distribution device for use in a storage system, the storage system comprising a plurality of storage servers, the data distribution device comprising a location recorder and a processor electrically connected with the location recorder, the data distribution method comprising the following steps:
(a1) recording locations of a plurality of hypervisors and the storage servers by the location recorder;
(b1) capturing information of at least one virtual machine related to the hypervisors by the processor;
(c1) creating a data distribution policy for the at least one virtual machine according to the information and the locations of the hypervisors and the storage servers by the processor; and
(d1) notifying the storage system of the data distribution policy by the processor.

9. The data distribution method as claimed in claim 8, wherein the step (d1) further comprises the following step:
(d11) notifying the storage servers of the data distribution policy by the processor so that the storage servers stores data of the at least one virtual machine according to the data distribution policy.

10. The data distribution method as claimed in claim 9, wherein the storage system further comprises at least one gateway server, and the step (d1) further comprises the following step:
(d12) notifying the at least one gateway server of the data distribution policy by the processor so that the at least one gateway server controls access of the data between the at least one virtual machine and the storage servers according to the data distribution policy.

11. The data distribution method as claimed in claim 8, wherein the processor captures the information from a virtualization infrastructure system via a management application programming interface.

12. The data distribution method as claimed in claim 8, wherein the locations of the hypervisors and the storage servers are recorded in internet protocol form.

13. The data distribution method as claimed in claim 8, wherein the information of the at least one virtual machine comprises creation information, deletion information, startup information, poweroff information and migration information.

14. The data distribution method as claimed in claim 8, wherein the storage system is a scale-out network attached storage system.
